(19) United States
(12) Patent Application Publication
(10) Pub. No.: US 2008/0295782 A1
(43) Pub. Date: Dec. 4, 2008

(54) Corrugated Recreational Device For Pets

(76) Inventor: Michael A. Ebert, St. Marys (CA)

Correspondence Address: Michael Ebert, 17563 Gregory Dr., RR 3, St. Marys, ON, N4X 1C6, CA

(21) Appl. No.: 11/757,456

(22) Filed: Jun. 4, 2007

(51) Int. Cl. A01K 15/02; B32B 3/28

(52) U.S. Cl. 119/706; 428/182

(57) ABSTRACT

A recreational device for pets is provided comprising a base having at least one exposed surface, said surface being corrugated or ribbed.

### FIELD OF THE INVENTION

The present invention relates to a device for pets, and in particular, to a device for pet recreation constructed from a corrugated material.

### BACKGROUND OF THE INVENTION

A variety of devices intended for pet recreation exist including devices such as scratching posts for clawed pets, e.g. cats, which attempt to provide an attractive alternative to furniture, and other valuables within a home, which a pet can use for scratching and stretching, thereby preventing or minimizing damage to furniture.

U.S. Pat. No. 3,486,485 to Kahanick describes one such device. In particular, Kahanick describes a cat clawing pad comprising a casing which forms an open top chamber into which a large number of corrugated cardboard laminations are stacked edge-wise to form a corrugated bundle such that the smooth surfaces of each are adjacent. The combined upper edges form a clawing surface which is attractive to cats.

A modified scratching apparatus is provided in U.S. Pat. No. 7,117,821. This apparatus comprises a casing and first and second scratching surfaces, each formed by superimposed edge portions of a stacked corrugated material. The scratching surfaces are disposed within the casing such that both vertical and horizontal scratching surfaces are provided allowing a cat to scratch one surface while rubbing up against another surface with its body.

Another apparatus for use by animals combines a corrugated material with an abrasive surface. This apparatus, which is described in U.S. Pat. No. 7,011,043, includes a corrugated bundle, formed as described above, mounted on an abrasive surface such as sandpaper. When an animal (e.g. a cat) claws the corrugated bundle of the apparatus, its claws extend through the channels of the corrugated bundle or tear through at least a portion of the bundle to contact the abrasive surface. Contact with the abrasive surface results in trimming and/or dulling of the animal's claws.

It would be desirable to provide a novel recreational device for use by a pet, for scratching or other play, that improves upon those provided in the prior art.

### SUMMARY OF THE INVENTION

A recreational pet device is now provided comprising an exposed corrugated or ribbed surface. The corrugated surface provides an ideal surface for pets to amuse themselves by hooking their claws into the ribs of the surface and tugging, massaging the pads of their paws and even provides a surface suitable for a pet to climb on.

Thus, in one aspect of the present invention, there is provided a device for use by a pet, said device comprising a base, said base having an exposed corrugated surface.

Embodiments of the invention will become apparent in the description that follows, and in the drawings in which:

### BRIEF DESCRIPTION OF THE DRAWINGS

FIG. 1 is a perspective view of a corrugated device in accordance with an embodiment of the invention;

FIG. 2 is a side view of alternative arrangements (A-D) of a corrugated device having one corrugated face;

FIG. 3 is a side view of alternative arrangements (A-E) of a corrugated device having two corrugated faces;

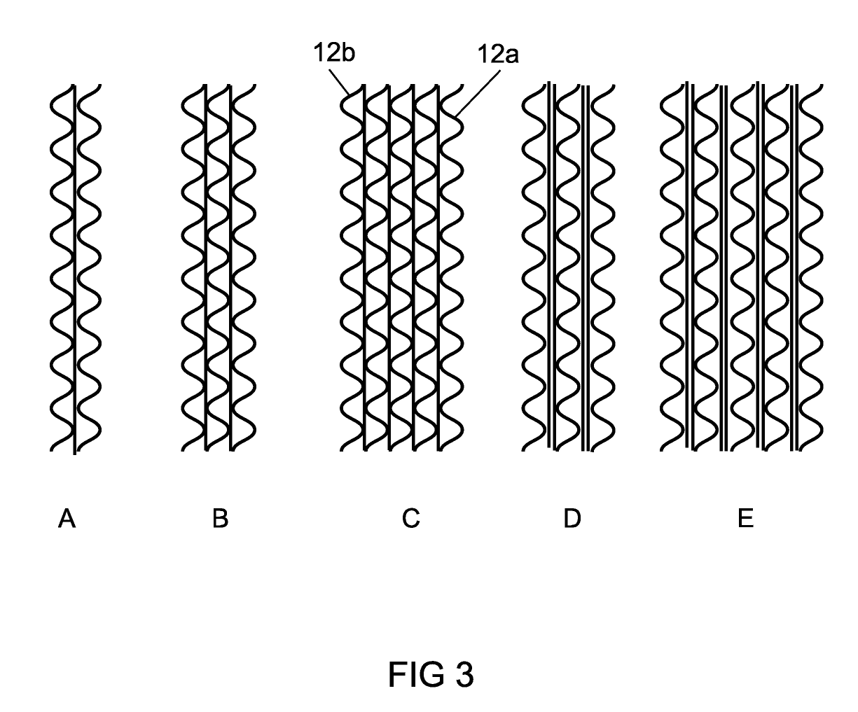

FIG. 4 is a side view of a device which illustrates use by a pet;

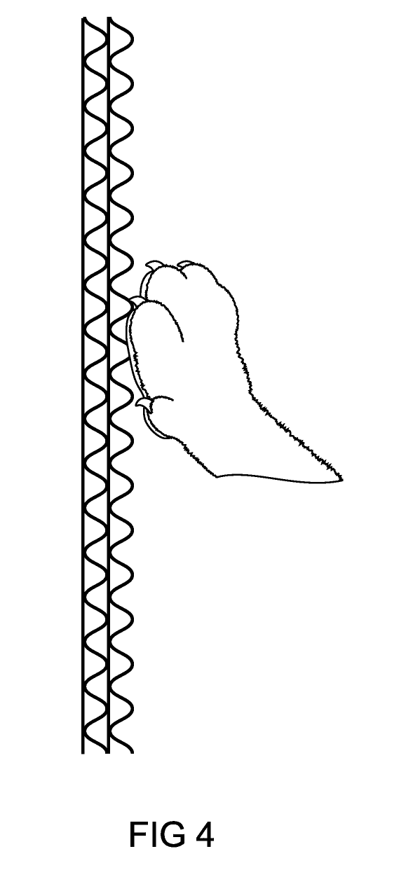

FIG. 5 is a perspective view of a device in accordance with the invention in which a corrugated sheet/bundle is bonded to a base material;

FIG. 6 is a side view of embodiments (A, B and C) of the device of FIG. 5;

FIG. 7 is a side view of a device in accordance with the invention which includes gripping feet mounted on the edges thereof;

FIG. 8 is a side view of an embodiment of the device of FIG. 7 including curved gripping feet;

FIG. 9 is a perspective view of a hinged device according to another embodiment of the invention; and

FIG. 10 is a perspective view of another hinged embodiment.

### DETAILED DESCRIPTION OF THE INVENTION

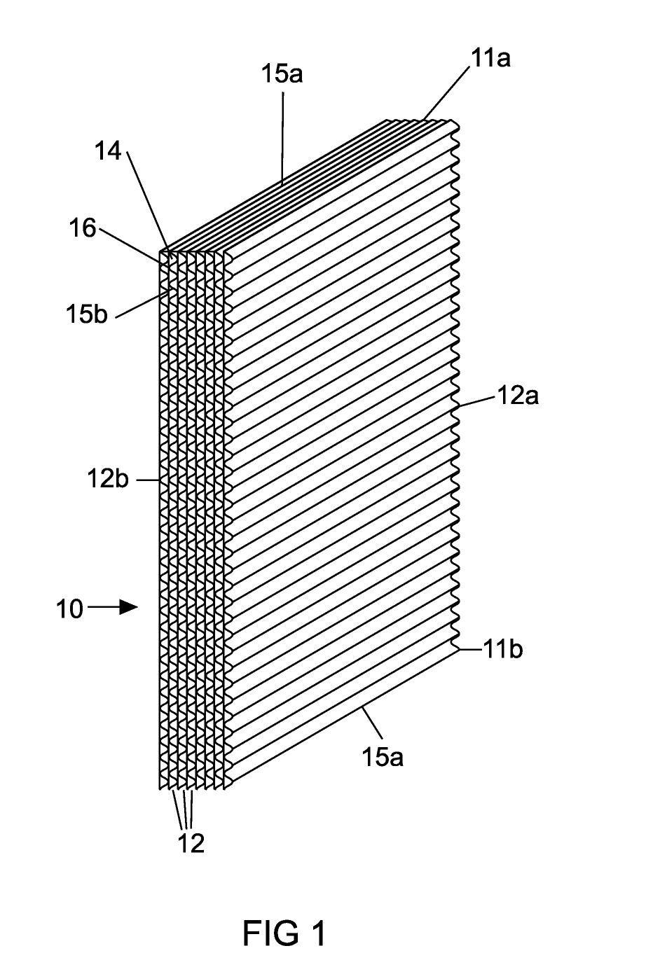

A device 10 is provided in one embodiment of the invention as shown in FIG. 1. The corrugated device 10 comprises a base having a plurality of corrugated sheets 12 bonded together to form a bundle having first and second exposed surfaces, 12a and 12b. Each sheet 12 is generally rectangular in shape, although the sheets may be any shape, having at least a first face 14, a second face 16 and an edge 11 around the perimeter of the faces 14, 16. In addition, each sheet 12 is made of at least two layers, a corrugated or ribbed layer and a smooth layer, but may additionally include a third layer that may either corrugated or smooth. The first and second faces 14, 16 may either be a corrugated layer or a smooth layer.

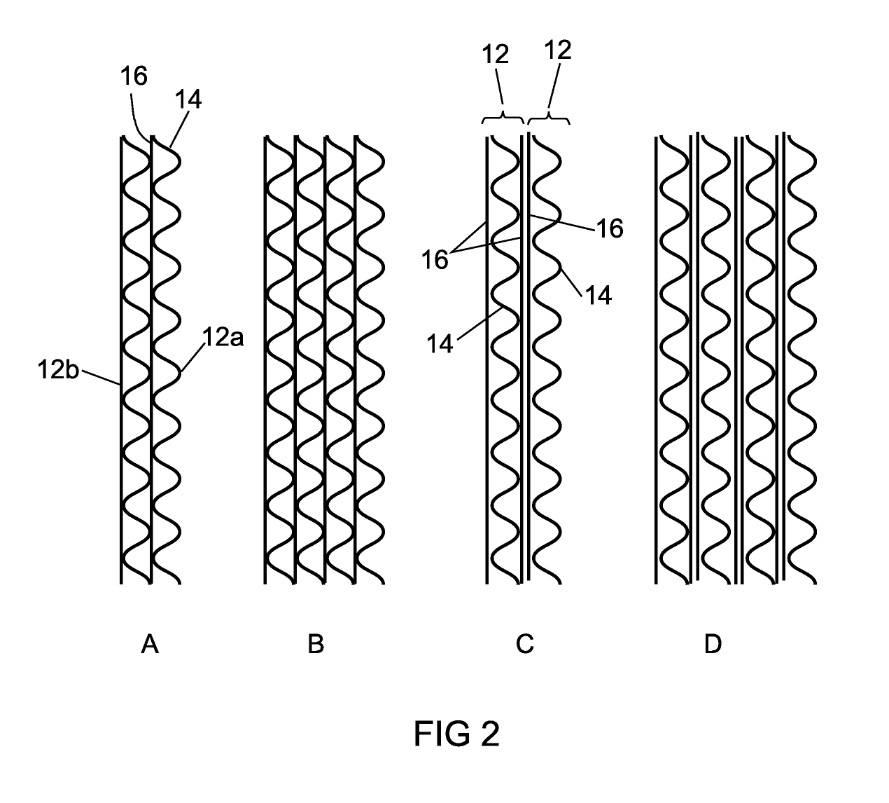

The corrugated device 10 is made by bonding at least two sheets 12 face to face with a suitable adhesive, such as glue, to form a bundle. The sheets 12 may be bonded smooth face to smooth face, corrugated face to corrugated face, or smooth face to corrugated face. Alternative arrangements of the sheets within a bundle are illustrated in FIG. 2 which shows devices having a corrugated first exposed surface 12a and a smooth second surface 12b. FIG. 2A and 2B illustrate devices comprising sheets 12 having a corrugated and a smooth layer. In this case, the bundle is formed by bonding the corrugated face 14 of one sheet 12 to the smooth face 16 of a second sheet 12. FIG. 2C and 2D illustrate devices additionally comprising sheets 12 having two smooth faces 14,16 with a corrugated layer in between. In this case, the bundle is formed by bonding corrugated faces to smooth faces, as well as bonding smooth faces to smooth faces as indicated by the double lines in FIGS. 2C and 2D.

In bonding the sheets, the device 10 will comprise first and second exposed surfaces 12a, 12b, at least one of which is a corrugated face, and an edge (11) around the perimeter of the device. Selection of the adhesive to bond the sheets 12 together may of course vary with the type of material used to make the sheets 12, as will be appreciated. The corrugated sheets 12 will generally be made out of cardboard; however, other materials may be developed which are appropriate for use to make the device 10. Other materials may also be incorporated within the bundle to form embodiments of the device 10, as will described.

The ribs of the exposed corrugated face (12a) are not restricted with respect to the direction in which they extend. Thus, the ribs may extend in a cross-wise direction, substantially parallel to a top or bottom edge (11a) of the device (10). Alternatively, the ribs may extend in a longitudinal direction that is substantially parallel to side edges (11b) of the device (10). The ribs may also extend in a diagonal direction across the exposed surface 12a.

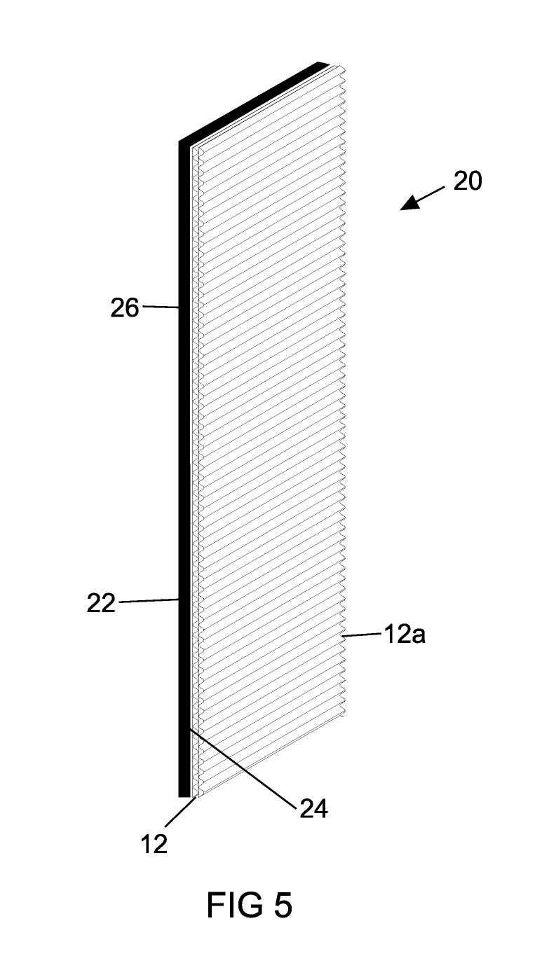

To achieve a similar result, a device 20 may be provided in which a corrugated bundle or device 10 as described above, or a single sheet 12, having an exposed corrugated surface 12a, is bonded onto a non-corrugated base 22 to yield a device with an exposed corrugated surface 12a as shown in FIG. 5.

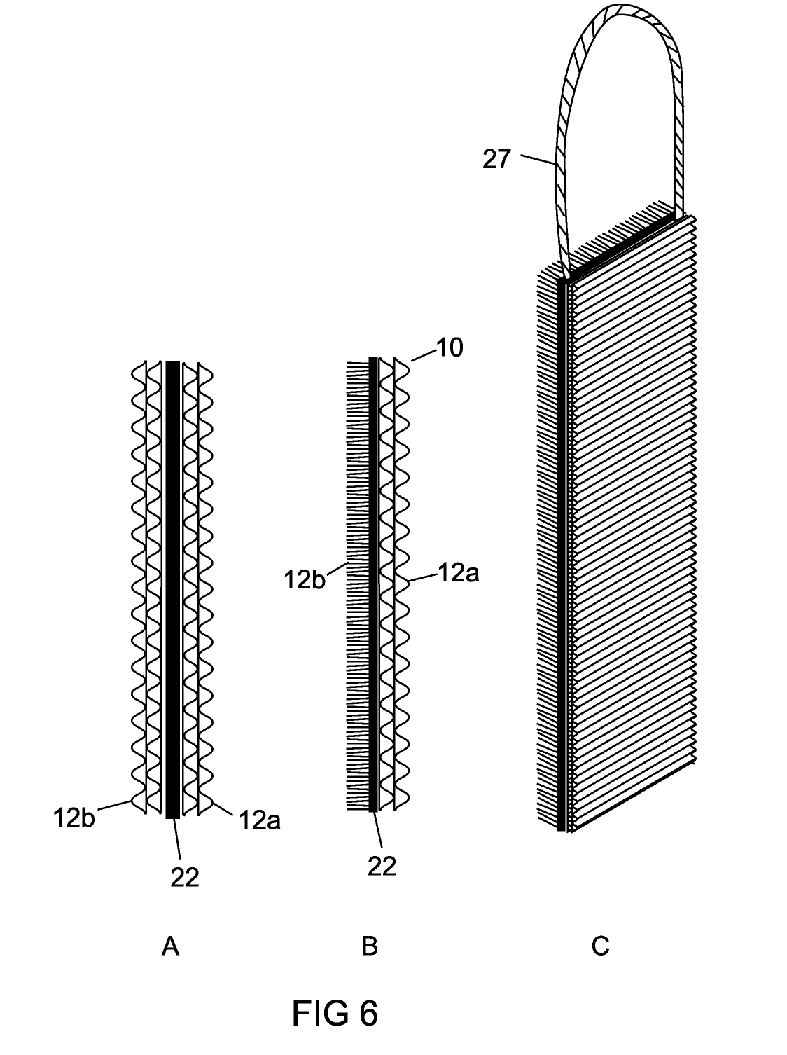

The non-corrugated base 22 comprises a first face 24 and a second face 26. The corrugated bundle 10 or sheet 12 is bonded onto one of the faces 24, 26 of the base 22 using a suitable adhesive which may vary with the nature of the base 22. A second corrugated bundle 10 or sheet 12 may additionally be bonded onto the other face 24, 26 of the base 22 to provide a device having two corrugated surfaces 12a, 12b as shown in FIG. 6A.

The base 22 may be selected for some desired property, e.g. rigidity or durability, and thus, may comprise, for example, a sheet of wood, rubber, plastic, a styrene polymer such as Styrofoam™, metal, cardboard or any other suitable paper product, or any other material suitable to provide the selected desired property.

The base 22 may comprise a scratchable material, such as, but not limited to, fabric, cloth, textile, carpet, carpet tile, durable padding, sisal and other like materials, thereby providing a device having a corrugated surface 12a and a scratchable surface 12b as shown in FIG. 6B. The base 22 may be made entirely of a selected scratchable material if it has sufficient rigidity to maintain a selected shape in view of the scratching and clawing. In this regard, an example of a suitable material is carpet tile, such as that manufactured by Bently, Bretlin, Interface Flooring, J&J Industries, Lees, Milliken, Mohawk, and Shaw. Alternatively, the base 22 may comprise a rigid layer onto which is bonded a scratchable layer.

In one embodiment, a device in accordance with the present invention, is provided for placement on the floor, or up against wall, piece of furniture, or other surface, for use by a pet. The device 10 is positioned such that a corrugated surface is exposed. The corrugated surface desirably provides a surface attractive to a pet, such as cat, for pawing as the corrugations massages the pads of a pet's paws. Similarly, the pet can also massage other parts of their body by rubbing up against the corrugated surface. In addition, the ribs of the corrugated surface of the device provide an ideal surface for the pet to hook its claws into, to permit tugging, tearing and clawing, activities that cats in particular enjoy.

A device in accordance with the invention may be provided with a handle 27 for hanging on a doorknob, cupboard handle, wall hook or the like as shown in FIG. 6C. The handle is not particularly restricted as to its form or the material from which it is made, provided it functions to suspend the device in a manner that allows the device to be used by a pet. Thus, the handle may be made out of string, rope, fabric, plastic or other material and may be fastened to the device by any suitable fastening means including, but not limited to staples, adhesive, tape, clips and the like. The handle may also be fastened to the device by threading either one or both ends of the handle through holes formed in the device and knotting the end(s) to maintain the handle in a selected position on the device.

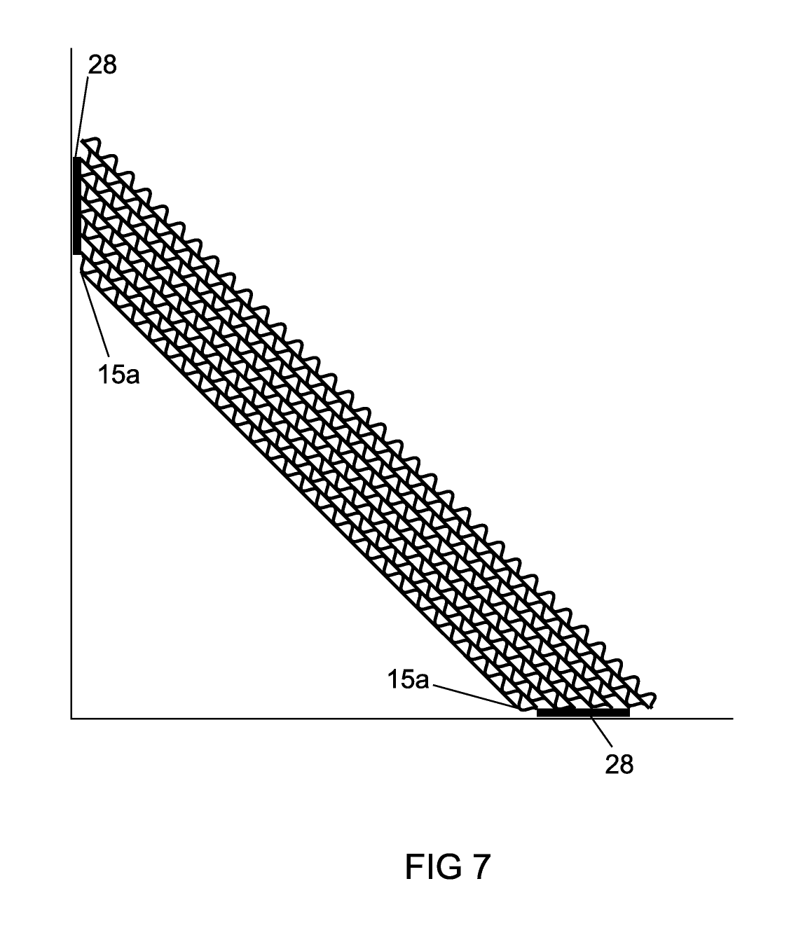

A device in accordance with the invention may optionally be provided with at least one gripping foot 28 mounted onto either the top or bottom ends 11a of the device to allow the device to be stably placed between first and second supporting surfaces, such as an upright or essentially vertical surface (e.g. a wall) and an essentially horizontal surface (e.g. a floor or the ground) as shown in FIG. 7. Preferably, at least one gripping foot is mounted onto both the top and bottom edges 11a of the device for greater stability.

The gripping feet 28 may comprise a strip of non-slip material or coating along the surface-contacting edge 11 thereof to allow the feet 28 to grip the surface on which they are resting thereby preventing slippage of the device, particularly when a pet is using the device. Examples of suitable non-slip materials that may be used include rubber or a like material. The gripping feet 28 may be entirely made of the non-slip material, partially made of the non-slip material or may have a strip or coating of the non-slip material applied thereto. The non-slip material may have a smooth surface, or may have a rough or irregular surface or a surface comprising protrusions which increase its gripping function. The non-slip material may be in the form of a suction cup which extends around the circumference of the surface-contacting edge 11 of the gripping foot 28, which utilizes suction to stick to the supporting surface. The non-slip material may also be an adhesive, such as an adhesive that does not leave a sticky residue behind.

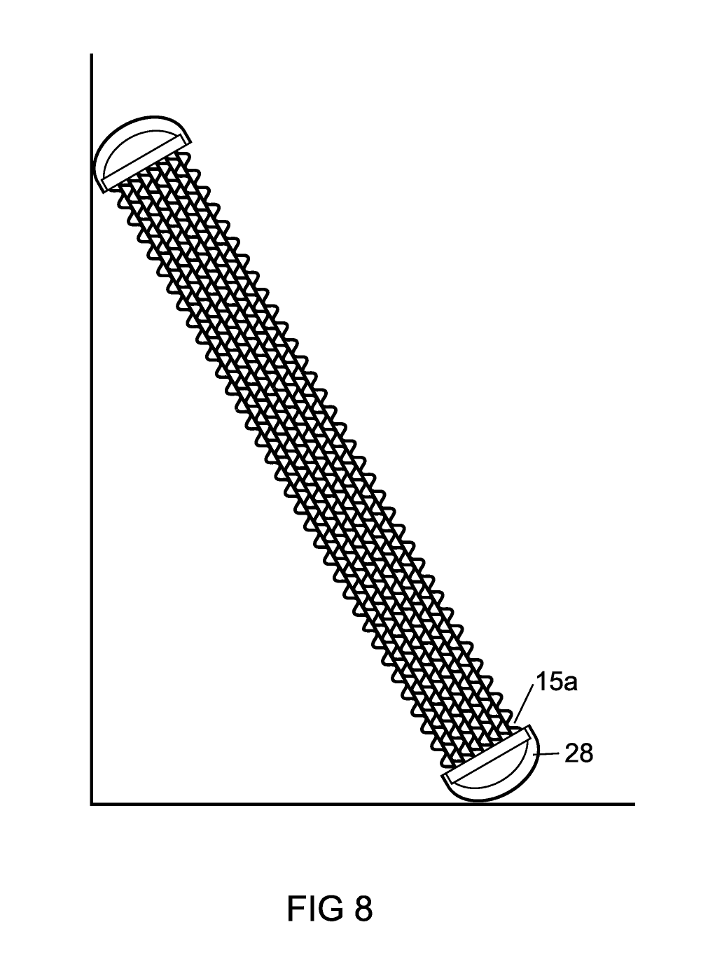

As shown in FIG. 8, and as described in co-pending U.S. patent application Ser. No. 11/747,369, the contents of which are incorporated herein by reference, the gripping foot 28 may, in one embodiment, have a curved surface which allows the device to be stably placed between first and second supporting surfaces at various angles, including angles within the range of about 10° to about 80° to the upright surface. The gripping feet 28 may be semi-circular (or other portion of a circle), for example, but may also be a semi-oval shape (or other portion of an oval), semi-polygonal shape or other shape which allows stable placement of the device at various angles.

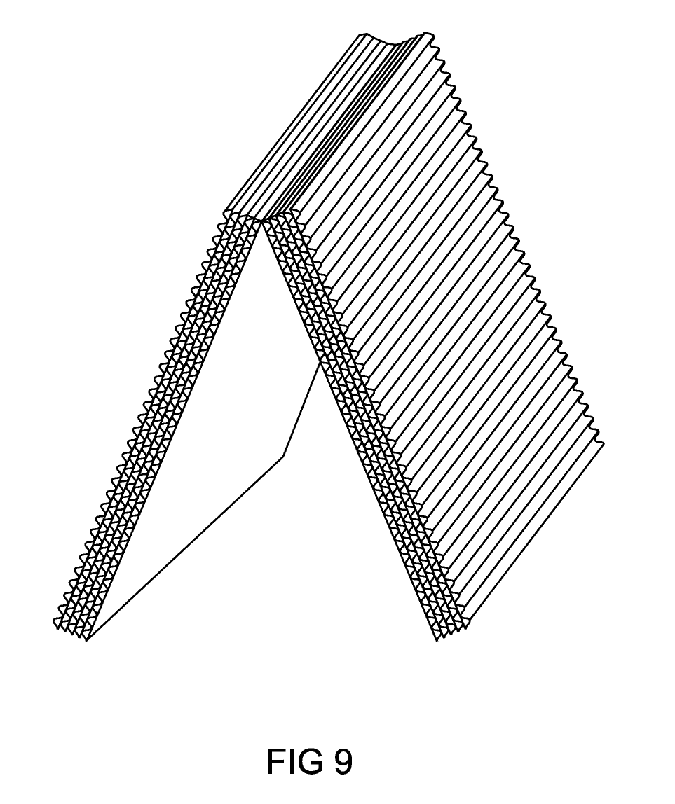

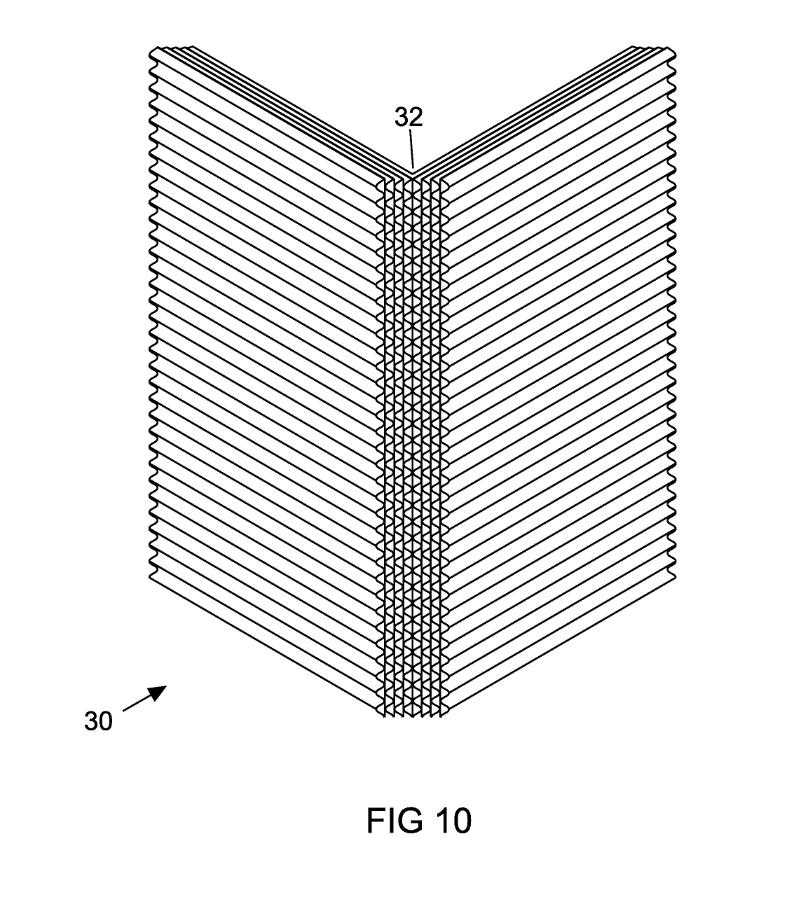

In another embodiment, and as illustrated in FIGS. 9 and 10, a device 30 may be provided as a unitary hinged device or a device having a hinge integrally formed therein. Such an integral hinge is provided in the device 30 by forming in the device a region of reduced thickness in comparison to the thickness of the rest of the device 30. This region of reduced thickness may be formed by making a partial cut or score through one of the exposed surfaces 12a or 12b of a device 10 as described and shown in FIG. 1. The cut may penetrate multiple layers of the device, but will not be a full cut through the entire width of the device (e.g. will not penetrate all layers of the device) and in particular, will not penetrate at least the layer of the opposing exposed surface (12b if the cut is initiated at surface 12a, or 12a if the cut is initiated at surface 12b). The uncut portion of the device functions as the hinge 32. To achieve a stronger hinge 32, the hinge may comprise two or more layers of the device by making a more shallow cut in the device. Alternatively, the hinge may be formed by compressing the region of the device where a hinge is desired to result in a region of reduced thickness. The hinge may also be formed by a combination of compression and partial scoring.

The hinge may be formed in a corrugated exposed surface (12a as shown in FIG. 1) to yield a device having at least a corrugated outer surface. The inner surface of the hinged device may be either smooth or corrugated. Similarly, the hinge may be formed in a smooth exposed surface (12b as shown in FIG. 1) to yield a device having a smooth outer surface and a corrugated inner surface.

The hinge may be formed in the direction of or parallel to the ribs of the corrugated surface. When the hinge is formed in this manner, a device as shown in FIG. 9 is provided which is useful as a free-standing device that can then be used by a pet for pawing, massaging, rubbing against, scratching or clawing. Alternatively, the hinge may be formed in a cross-wise or perpendicular direction to the ribs of the corrugated surface. When the hinge is formed in this manner, a device as shown in FIG. 10 is provided that is useful for placement up against the corner edge of a piece of furniture, wall or the like for use by a pet while affording protection of the furniture or wall.

To increase the desirability of a device in accordance with the invention, the device may be made with a corrugated material incorporating catnip in any suitable form. In this regard, catnip, readily available for purchase, may be applied as an oil to the corrugated material by spraying or other appropriate method of application. Alternatively, the catnip, in liquid or solid form, may be introduced into the corrugated material during its manufacture.

As will be appreciated, the device may be provided in a multitude of shapes to attract the attention of a pet, and encourage use by the pet. For example, the device may be shaped as a creature, such as a bird or mouse. The device may also be provided in a three-dimensional shape by incorporating one or more hinges therein to provide a device that may move or “interact” when touched by the pet.

The device may additionally include attachments hanging from or attached directly thereto to attract a pet, including for example a toy attachment such as a hanging ball or stuffed toy, a spring with pom pom or other attachment, or a catnip pouch. Other attachments may include items which bestow on the device an appealing appearance, such as a creature or play object.

The foregoing description relates to certain embodiments of the invention; however, as one of skill in the art will appreciate, other embodiments may exist which fall within the scope of the appended claims.

We claim:

1. A device for use by a pet, said device comprising a base having at least a first exposed surface which is corrugated.

2. A device as defined in claim 1, wherein the base comprises a plurality of sheets of a corrugated material, said sheets being bonded face to face to form a corrugated bundle having first and second exposed surfaces, wherein at least one of the exposed surfaces is corrugated.

3. A device as defined in claim 2, wherein the corrugated material is a cardboard material.

4. A device as defined in claim 2, wherein both first and second exposed surfaces are corrugated.

5. A device as defined in claim 2, wherein each sheet comprises at least a smooth layer and a corrugated layer.

6. A device as defined in claim 1, wherein the base comprises a non-corrugated material having first and second faces, and wherein a corrugated material is bonded to the first face of the base to form a first exposed corrugated surface.

7. A device as defined in claim 6, wherein a corrugated material is bonded to the second face of the base to form a second exposed corrugated surface.

8. A device as defined in claim 6, wherein a scratchable material is bonded to the second face of the base to form a second exposed scratchable surface.

9. A device as defined in claim 6, wherein the non-corrugated material is selected from the group consisting of plastic, wood, metal, a styrene polymer, a paper product and rubber.

10. A device as defined in claim 2, comprising an integral hinge, wherein the hinge is formed by reducing the thickness of the device in a selected region.

11. A device as defined in claim 10, wherein the hinge is formed by a partial cut in the selected region.

12. A device as defined in claim 10, wherein the hinge is formed in a direction that is substantially perpendicular to the ribs of the corrugated surface.

13. A device as defined in claim 10, wherein the hinge is formed in a direction substantially parallel to the ribs of the corrugated surface.

14. A device as defined in claim 10, wherein the hinge is formed by compressing the selected region.

15. A device as defined in claim 1, comprising a corrugated material which includes catnip.

16. A device as defined in claim 1, comprising at least one gripping foot mounted on a surface-contacting edge of the device.

17. A device as defined in claim 16, comprising a least one gripping foot mounted on both a top and bottom surface-contacting edge of the device.

18. A device as defined in claim 16, wherein the gripping foot is comprised of rubber.

19. A device as defined in claim 10, comprising at least one integrally formed hinge to form a device having a three-dimensional shape.

20. A device as defined in claim 16, wherein the gripping foot is shaped to permit stable placement of the device at multiple angles.
